(19) United States
(12) Patent Application Publication
(10) Pub. No.: US 2008/0263433 A1
(43) Pub. Date: Oct. 23, 2008

(54) Multiple version merge for media production

(76) Inventors: Aaron Eppolito, Santa Cruz, CA (US); James Jocob Hodges, Santa Clara, CA (US); Jerremy Holland, Los Altos Hills, CA (US); Nikhill Mahesh Shalt, Cupertino, CA (US); Christopher Sanders, Santa Clara, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/082,898

(22) Filed: Apr. 14, 2008

Related U.S. Application Data
(60) Provisional application No. 60/911,886, filed on Apr. 14, 2007.

(51) Int. Cl. G06F 17/00; G06F 3/048

(52) U.S. Cl. 715/200; 715/723

(57) ABSTRACT

Methods, graphical user interfaces, computer apparatus and computer readable medium for merging different versions of multimedia project (e.g., movie) are disclosed. For example, modifications separately and concurrently made to multimedia assets of a multimedia project in production can be efficiently and intelligently merged. The multimedia assets can be audio, video or graphical elements.

### CROSS-REFERENCE TO OTHER APPLICATION

This application claims priority to U.S. Provisional Patent Application No. 60/911,886, filed Apr. 14, 2007, entitled “MULTIPLE VERSION MERGE FOR MEDIA PRODUCTION”, which is herein incorporated herein by reference.

This application is also related to U.S. patent application Ser. No. ______, filed Apr. 14, 2008, entitled “SYSTEM AND METHOD TO CONFORM SEPARATELY EDITED SEQUENCES”, which is herein incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever.

### BACKGROUND OF THE INVENTION

In the course of producing a picture, such as a movie, it is common for an audio engineer (sound editor) to add audio clips (or segments) as well as audio properties (e.g., equalization, reverberation, voice matching, room sounds) to audio clips. The audio clips and audio properties therefore can form a sound mix (or audio mix) for a corresponding video track. The audio clips can be provided in one or more audio tracks for the video track. The formation of a sound mix takes substantial effort and can be referred to as audio production.

However, while audio production is being performed on a picture (video cut), a picture editor often separately continues to edit the picture. For example, the picture editor might move or edit various sequence of the video track. Thereafter, the edited video can be provided to the audio engineer to add, modify and/or delete audio clips. The audio engineer is then required to manually rearrange the sound mix from the former video to fit with the edited video.

Conventionally, when manually conforming a sound mix to a new video edit, an audio engineer (sound editor) imports the picture editor's newly arranged audio clips and video into an existing multi-track project on new tracks. Next, the audio engineer can walk through the audio edits one by one, comparing the old placement of audio clips to the placement of new audio clips. Audio clips from the former video cut must be adjusted so that they are properly aligned with the new video cut. Audio clips may also need to be added or deleted because a scene was deleted or added.

There are software programs that assist audio engineers with placing and editing audio clips, including configuring audio properties for the video clips. One example of an existing software program for audio editing/production application is “Soundtrack Pro” available from Apple Inc. of Cupertino, Calif. Even so, it is a tedious manual task of adjusting audio clips from a former video sequence to a new video sequence. Hence, there is a need to provide improved approaches to adjust audio clips from one video sequence to another video sequence.

### SUMMARY OF THE INVENTION

The invention pertains to methods, graphical user interfaces, computer apparatus and computer readable medium for merging different versions of a digital media asset (e.g., movie). For example, a user of a computing device can utilize the methods, graphical user interfaces, computer apparatus, and computer readable medium to merge modifications separately and concurrently made to a digital media asset in production. The digital media assets can be audio, video or graphical.

The invention can be implemented in numerous ways, including as a method, system, device, apparatus (including graphical user interface), or computer readable medium. Several embodiments of the invention are discussed below.

As a computer readable medium including at least executable computer program code tangibly stored thereon for audio editing a video sequence, one embodiment of the invention can, for example, include at least: computer program code for receiving a first media cut of a multimedia project; computer program code for associating a plurality of media elements to the first media cut; computer program code for receiving a second media cut of the multimedia project; computer program code for analyzing the first media cut and the second media cut to propose modification of the media elements with respect to the second media cut; and computer program code for accepting, declining or modifying the proposed modification of the media elements with respect to the second media cut.

As a computer-implemented method for merging media sequences, one embodiment of the invention can, for example, include at least: identifying a first media sequence having a plurality of media elements that have been associated therewith; altering the first media sequence to provide an altered first media sequence having a plurality of media elements that have been associated therewith; identifying a second media sequence that resulted from editing of the first media sequence; and determining where a plurality of the media elements that are associated with the altered first media sequence might likely be positioned with respect to the second media sequence. Optionally, one embodiment of the invention can further include forming a third media sequence from the second media sequence and a plurality of the media elements associated with the altered first media sequence.

As a graphical user interface, one embodiment of the invention can, for example, include at least: an editor pane configured to display a media clip review region that displays a list of media clips with proposed modifications for at least one of the media clips. The media clips were previously associated with a first media sequence and the proposed modifications are to transition the media clips to a second media sequence, where the second media sequence is derived from the first media sequence.

As a graphical user interface, one embodiment of the invention can, for example, include at least: a timeline pane configured to present a first timeline for a first video sequence and a second timeline for a second video sequence; and an editor pane configured to display an audio clip review region that displays a list of audio clips at proposed positions with respect to the second video sequence or a new third video sequence derived from the second video sequence. The audio clips in the list of audio clips can be previously associated with (e.g., added to) the first video sequence but not the second video sequence. At least a subset of the audio clips in the list of audio clips are automatically transitioned to the second video sequence or the third video sequence with the proposed modifications.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

The invention will be readily understood by the following detailed description in conjunction with the accompanying drawings, wherein like reference numerals designate like structural elements, and in which:

FIG. 1A is a block diagram of a digital media production system according to one embodiment of the invention.

FIG. 1B is a diagram of a digital media production environment according to one embodiment of the invention.

FIG. 2A is a flow diagram of a conform process according to one embodiment of the invention.

FIG. 2B is a flow diagram of an options process according to one embodiment of the invention.

FIGS. 3A and 3B are flow diagrams of a conform process according to one embodiment of the invention.

FIG. 4 is a flow diagram of a review process according to one embodiment of the invention.

FIG. 5 is an exemplary screenshot of a conform window according to one embodiment of the invention.

FIGS. 6A-6I are screenshots of exemplary graphical user interfaces according to embodiments of the invention.

FIG. 7 is a flow diagram of a clip identification process according to one embodiment of the invention.

FIG. 8A is a flow diagram of the clip placement process according to one embodiment of the invention.

FIG. 8B is a flow diagram of the clip placement process according to one embodiment of the invention.

FIG. 9 shows an exemplary computer system suitable for use with the invention.

### DETAILED DESCRIPTION OF THE INVENTION

The invention pertains to methods, graphical user interfaces, computer apparatus and computer readable medium for merging different versions of a multimedia project (e.g., movie). For example, a user of a computing device can utilize the methods, graphical user interfaces, computer apparatus, and computer readable medium to merge modifications separately and concurrently made to a multimedia project in production. The multimedia project can include audio, video and/or graphical elements.

In one embodiment, the invention can be implemented by a conform tool. A conform tool is able to automatically merge two versions of the same multimedia project in production. The merged version can be reviewed. In particular, the conform tool can also assist with the review of various merge decisions, which can be accepted, declined or altered. The different versions can results from a single program or from multiple programs.

Although the invention is largely described below as merging versions with respect to positioning of media elements (e.g., clips) in media sequences, it should be understood that modifications to different versions are not limited to positioning but can additionally or alternatively pertain to one or more of duration (length), media, and media offset.

Although the invention is primarily described herein as pertaining to merging different versions of a multimedia project, it should be understood that the invention is not limited to multimedia projects or media sequences. For example, the merging of different version of any data can utilized the conform processing discussed below. Besides media data, the data could, for example, be notes, markers, annotations, etc. that are added or associated with different versions.

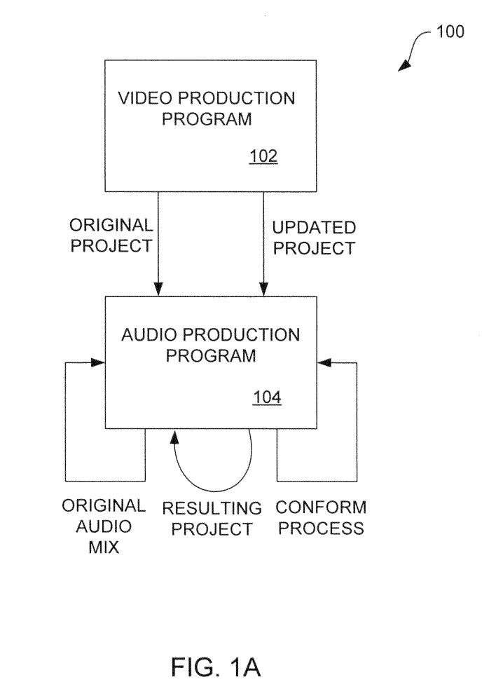

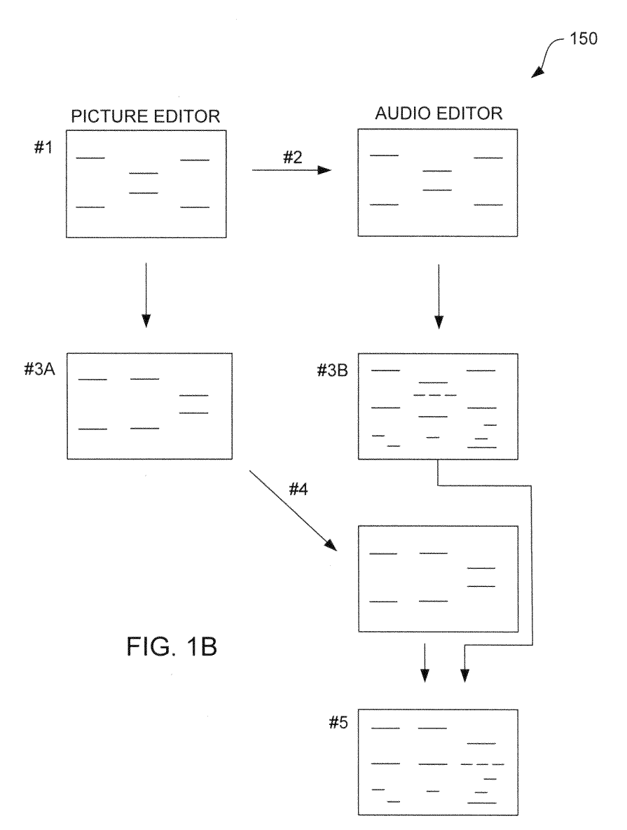

Embodiments of the invention are discussed below with reference to FIGS. 1A-9. However, those skilled in the art will readily appreciate that the detailed description given herein with respect to these figures is for explanatory purposes as the invention extends beyond these limited embodiments.

FIG. 1A is a block diagram of a digital media production system 100 according to one embodiment of the invention. The digital media production system 100 includes a video production program 102 and an audio production program 104. As an example, the video production program 102 can pertain to Final Cut Pro 6™ available from Apple Inc. of Cupertino, Calif., and the audio production program can pertain to Soundtrack Pro 2™ available from Apple Inc. of Cupertino, Calif.

The video production program 102 can be used to create an original project that includes at least one video track and may also include various audio tracks. For example, a picture editor can use the video production program 102 to manipulate video clips/tracks to form a desired resulting video (i.e., video sequence), such as for a movie. Often the video clips/tracks contain or are associated with audio clips.

The original project can be provided to an audio production program 104 so that a sound editor (audio editor) can create an original audio mix to be used with the video. Typically, the audio mix is a mixture of audio sounds from a plurality of different audio tracks. However, as the sound editor is creating the audio mix, the picture editor is producing an updated project (e.g., having at least an altered video track) as compared to the original project. As a result, it is not uncommon for an updated project to be provided to the sound editor after the sound editor has created at least parts of the audio mix to be used with the video. Hence, the audio production program 104 can include a conform process that assists the sound editor is moving the original audio mix associated with the original project to a resulting audio mix for the updated project. A resulting project can be formed that uses the video from the updated project and the resulting audio mix for the audio. In one embodiment, the conform process recommends or suggests positions and/or properties for audio elements of the original audio mix. In other words, the conform process can attempt to conform the original audio mix from the original project to match the video from the updated project.

FIG. 1B is a diagram of a digital media production environment 150 according to one embodiment of the invention. A picture editor and an audio editor utilize the digital media production environment 150 to produce a movie (i.e., motion picture). The exemplary steps carried out in producing a movie are illustrated in the digital media production environment 150. In step 1, the picture editor creates an initial arrangement of video/audio clips for the movie. In step 2, the picture editor releases the initial arrangement to the audio editor. Thereafter, in step 3A, the picture editor can modify the arrangement of the video/audio clips, and in step 3B, the audio editor can also modify the arrangement. Here, the picture editor can add, remove or move audio/video clips with respect to a timeline. The audio editor typically adds or modifies audio clips working from a timeline established by the picture editor. Accordingly, steps 3A and 3B can be separate but can be concurrently performed. In step 4, the picture editor can release the updated arrangement to the audio editor. In step 5, the audio editor conforms the updates they have made in step 3B to the updated arrangement from the picture editor. Subsequently, the steps 3A, 3B, 4 and 5 can repeat for additional modified arrangements.

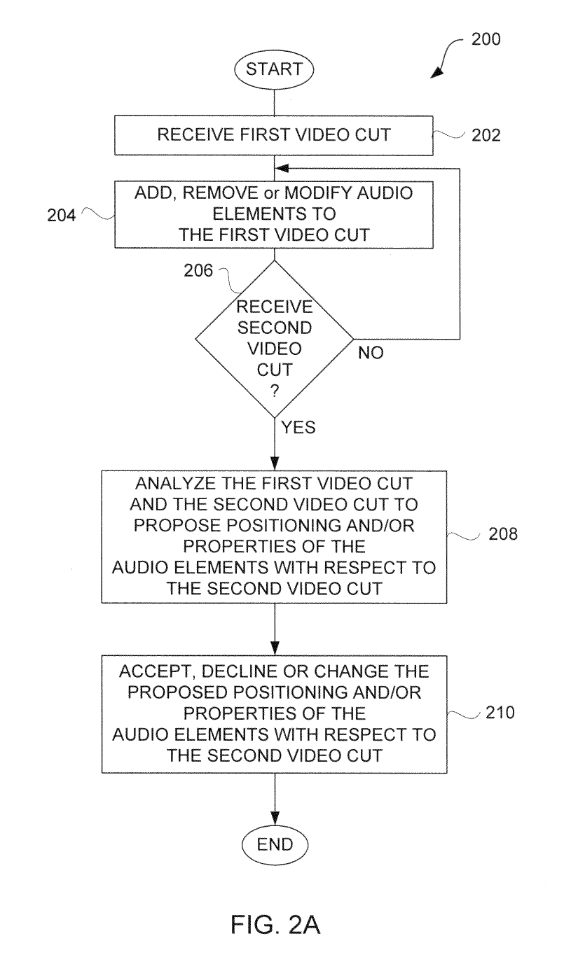

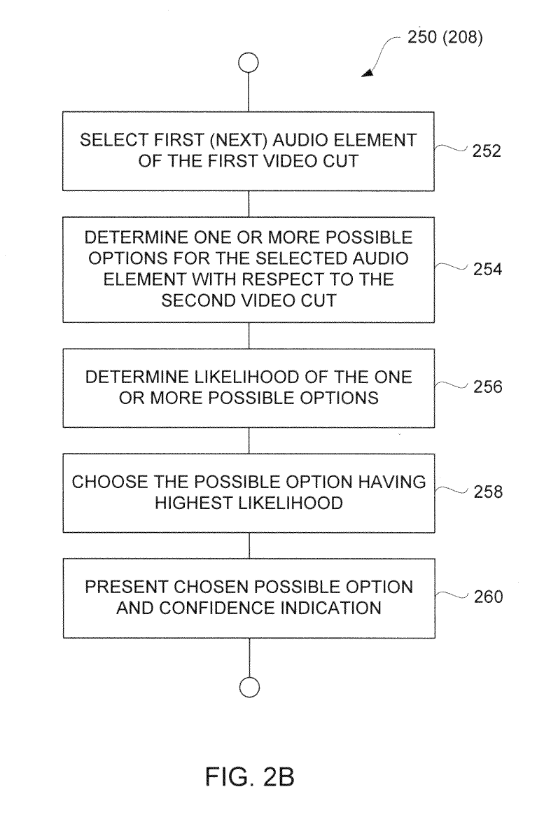

FIG. 2A is a flow diagram of a conform process 200 according to one embodiment of the invention. The confirm process 200 can, for example, be processing performed by an audio production program, such as the audio production program 104 illustrated in FIG. 1.

The conform process 200 can receive 200 a first video cut (video sequence). The first video cut can, for example, be provided by a video production program. After receiving 200 the first video cut, audio elements can be added, removed or modified 204 to the first video cut. For example, one or more audio elements in one or more audio tracks can be added with the first video cut.

A decision 206 then determines whether a second video cut has been received. The second video cut is a video cut of a video provided sometime after the first video cut. The second video cut has been modified as compared to the first video cut. When the decision 206 determines that the second video cut has not been received, then the conform process 200 can return to repeat the block 204 so additional audio elements can be added, removed or modified 204. On the other hand, when the decision 206 determines that the second video cut has been received, the conform process 200 can analyze 208 the first video cut and the second video cut to propose positioning and/or properties of the audio elements with respect to the second video cut. The proposed positioning and/or properties of the audio elements with respect to the second video cut can then be accepted, declined or changed 210. In otherwords, the proposed positioning and/or properties can be reviewed. For example, a user (e.g., sound editor) of the audio production program can review the proposed positioning and/or properties. By reviewing the proposed positioning and/or properties, the user can accept, decline or change the proposals. A graphical user interface can assist the user in reviewing (e.g., accepting, declining or changing) the proposed positioning and/or properties.

FIG. 2B is a flow diagram of an options process 250 according to one embodiment of the invention. The options process 250 is, for example, processing that can be performed by the block 208 illustrated in FIG. 2A.

The options process 250 can initially select 252 a first audio element of the first video cut. Next, one or more possible options for the selected audio element can be determined 254 with respect to the second video cut. These different options can differ in position and/or properties for the selected audio element. In addition, the likelihood of the one or more possible options can be determined 256. The possible option having the highest likelihood can then be chosen 258. The chosen possible option can also be referred to as the proposed option. Thereafter, the chosen possible option can be presented 260 along with a confidence indication. The confidence indication is a visual indication that can be displayed to inform the user of the confidence the system has in the chosen possible option. As this point, the options process 250 is completed so processing can return to block 210 of FIG. 2A.

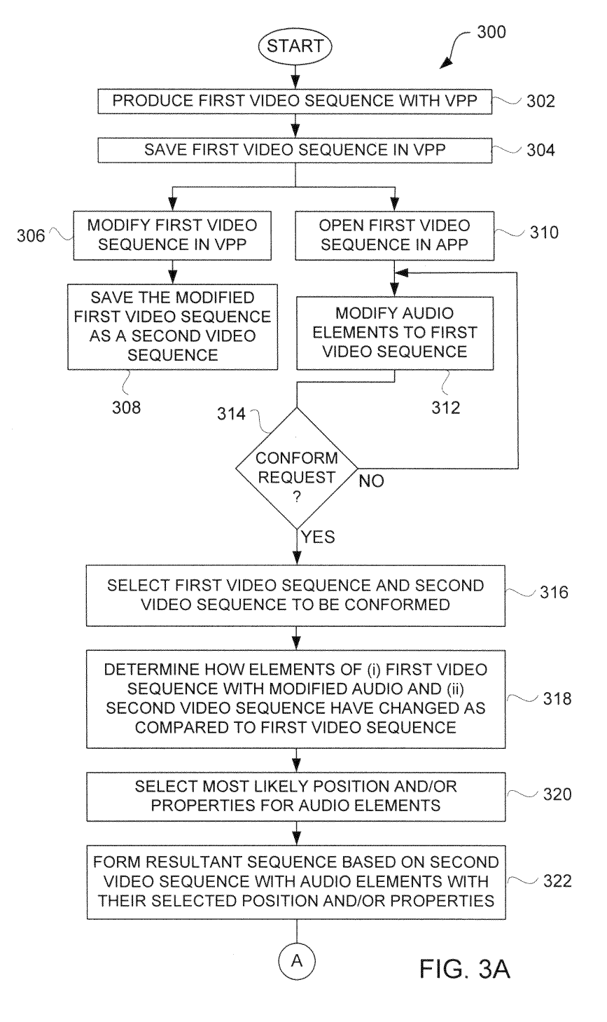

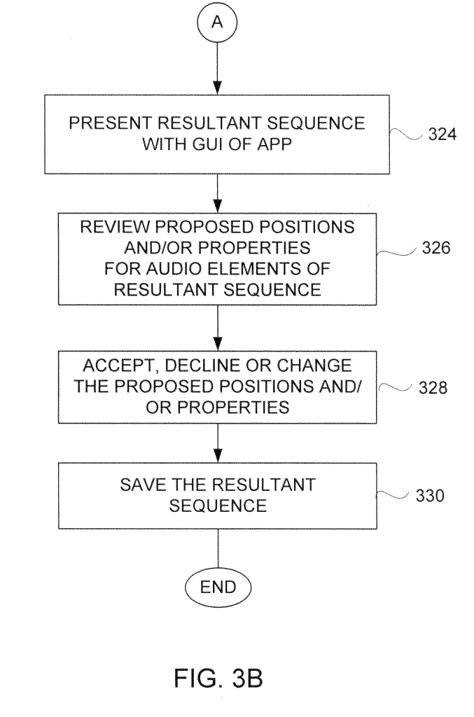

FIGS. 3A and 3B are flow diagrams of a conform process 300 according to one embodiment of the invention. The confirm process 300 can, for example, be processing performed by an audio production program, such as the audio production program 104 illustrated in FIG. 1. The conform process 300 can utilize a video production program (VPP) and an audio production program (APP).

Initially, the conform process 300 produces 302 a first video sequence with the video production program. The first video sequence in the video production program can then be saved 304.

Next, the first video sequence can be modified 306 in the video production program. The modified first video sequence can then be saved 308 as a second video sequence. Concurrent with the modifying 306 and the saving 308 of the second video sequence, the conform process 300 can also open 310 the first video sequence in the audio production program. Then, using the audio production program, audio elements of the first video sequence can be modified 312.

Following the block 312, a decision 314 can determine whether a conform request has been made. Here, a user of the audio production program can interact with a graphical user interface to request that a conform operation be initiated. As an example, the conform operation can be initiated by a menu selection or a button action. When the decision 314 determines that a conform operation has not been requested, the conform process 300 can return to repeat the block 312 so that the user of the audio production program can continue to modify 312 the audio elements within the first video sequence and/or request a conform operation.

On the other hand, when the decision 314 determines that a conform request has been made, the first video sequence and the second video sequence to be conformed are selected 316. Here, the first video sequence is the video sequence resulting from block 312, and the second video sequence is the second video sequence saved in block 308. The conform process 300 can then operate to determine 318 how elements of the first video sequence having subsequently modified audio and the second video sequence have changed as compared to the first video sequence which was saved at block 304. Next, most likely positions and/or properties for the audio elements can be selected 320 to match the second video sequence. A resultant sequence can then be formed 322 based on the second video sequence with audio elements in their selected position and/or properties.

Thereafter, the resultant sequence can be presented 324 within a graphical user interface of the audio production program. The graphical user interface can be referred to as a conform graphical user interface. After the resultant sequence is presented 324, the proposed positions for the audio elements can be reviewed 326. In doing so, the user of the audio production program can accept, decline or change the proposed positions and/or properties for the audio elements. Following the block 328, the resultant sequence can be saved 330. After the block 330, the conform process 300 can end.

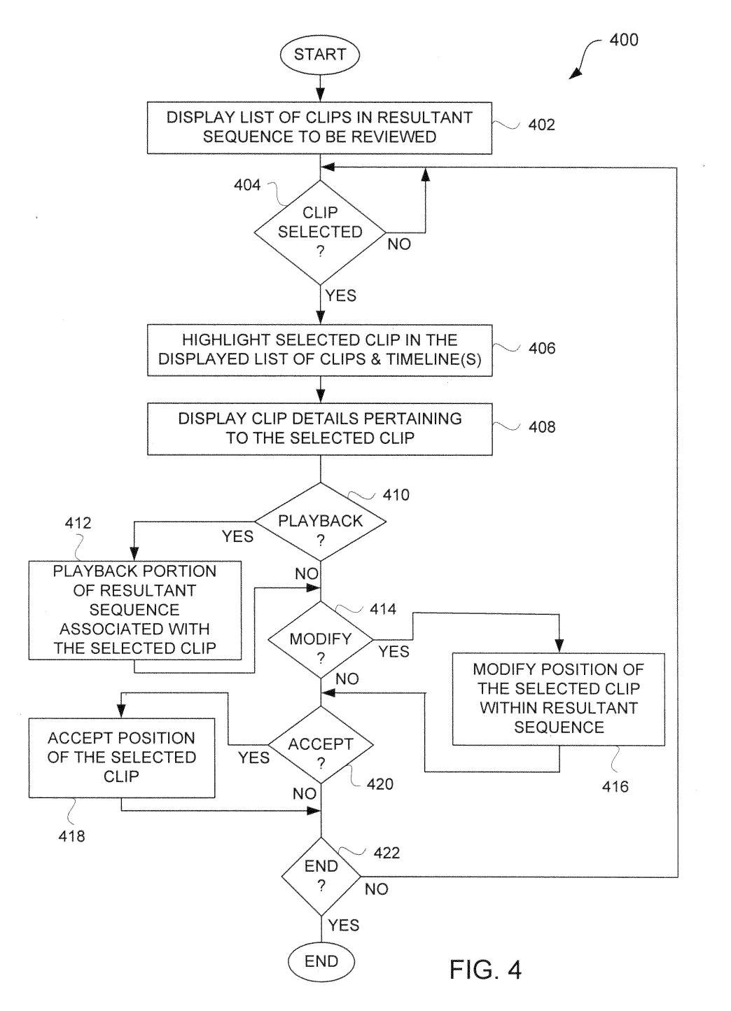

FIG. 4 is a flow diagram of a review process 400 according to one embodiment of the invention. The review process 400 is, for example, processing that can be carried out by blocks 326 and 328 of the conform process 300 illustrated in FIG. 3B.

The review process 400 can initially display 402 a list of clips in the resultant sequence to be reviewed. In one embodiment, the list of clips includes those one or more clips (e.g., audio elements) that have been added, changed or removed relative to the first sequence. In one implementation, the list of clips can provide a confidence level for the proposed change, and positional reference positions (original, resulting and/or difference) for each of the clips. A decision 404 then determines whether one of the clips in the resultant sequence has been selected. When the decision 404 determines that a clip has not been selected, the review process 400 can await a selection of a clip.

Once the decision 404 determines that a clip has been selected (e.g., by a user of the audio production program), the selected clip can be highlighted 406 in the displayed list of clips. More generally, by highlighting the selected clip, the selected clip is displayed in a visually distinct manner. In other words, the selected clip is distinctively displayed. In addition, clip details pertaining to the selected clip can be displayed 408. The clip details provide detailed information regarding the selected clip, including for example: name, whether position/duration has changed, and/or whether media for the clip has changed. The position of the selected clip can also be distinguishably displayed with respect to a timeline. Alternatively, when the clip is selected using the timeline, the selected clip can be distinctively displayed in the list of clips.

In reviewing the clips within the list of clips, the user can interact with the audio production program. With respect to FIG. 4, after the clip details for the selected clip have been displayed 408, a user can interact with the audio production program in various ways. A decision 410 can determines whether playback of the selected clip has been requested. When the decision 410 determines that playback on the selected clip has been requested, a portion of the resultant sequence associated with the selected clip can be played back 412. Following the block 412, or following the decision 410 when playback is not requested, a decision 414 can determine whether the selected clip is to be modified. Here, the user of the audio production program can interact with the selected clip to modify the selected clip in any of a variety of different ways. For example, the position and/or length of the selected clip can be modified. When the decision 414 determines that the selected clip is to be modified by user interaction with the audio production program, the position of the selected clip within the resultant sequence can be modified 416 in accordance with the user interaction. In one implementation, the position of the selected clip can be moved while being playback. Following the block 416, as well as following the decision 414 when the selected clip has not been modified, a decision 420 determines whether the selected clip at its current position is to be accepted (or declined). When the decision 420 determines that the selected clip at its current position (proposed position or modified position) is accepted, the audio production program can then process the acceptance 418 of the position of the selected clip. Also, although blocks 416 and 418 pertain to position of the selected clip, the selected clip also has properties that can be proposed, modified and accepted separately or together with position. Examples of properties can, for example, include start time, duration, media, and media offset.

Following the block 418, or following the decision 420 when the selected clip has not been accepted, a decision 422 can determine whether the review process 400 should end. When the decision 422 determines that the review process 400 should not, then the review process 400 returns to repeat the decision 404 so that another clip can be processed in a similar manner. Alternatively, when the decision 422 determines that the review process 400 should end, then the review process 400 can end.

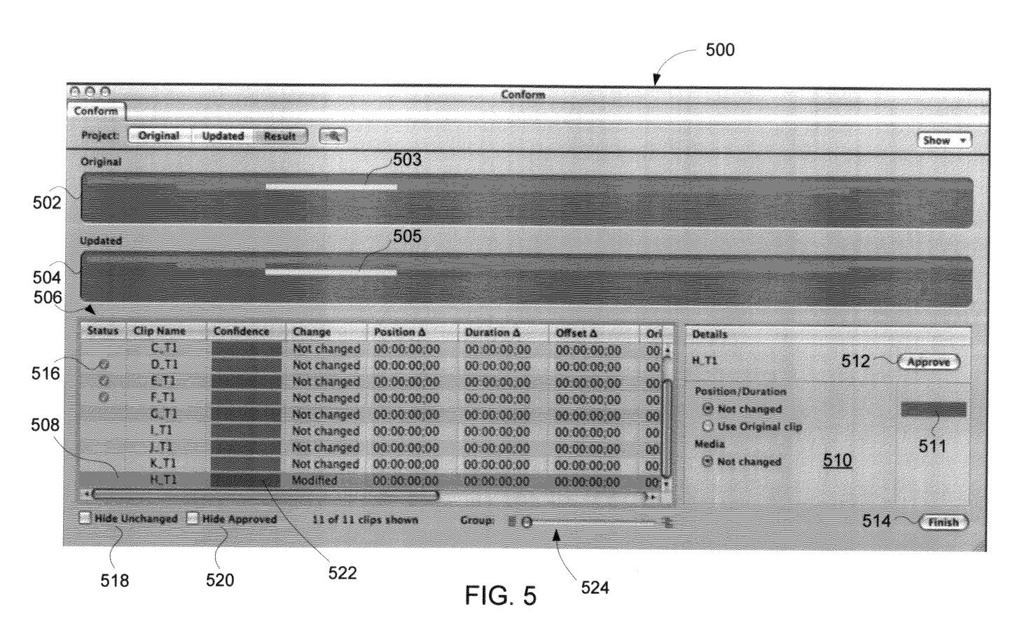

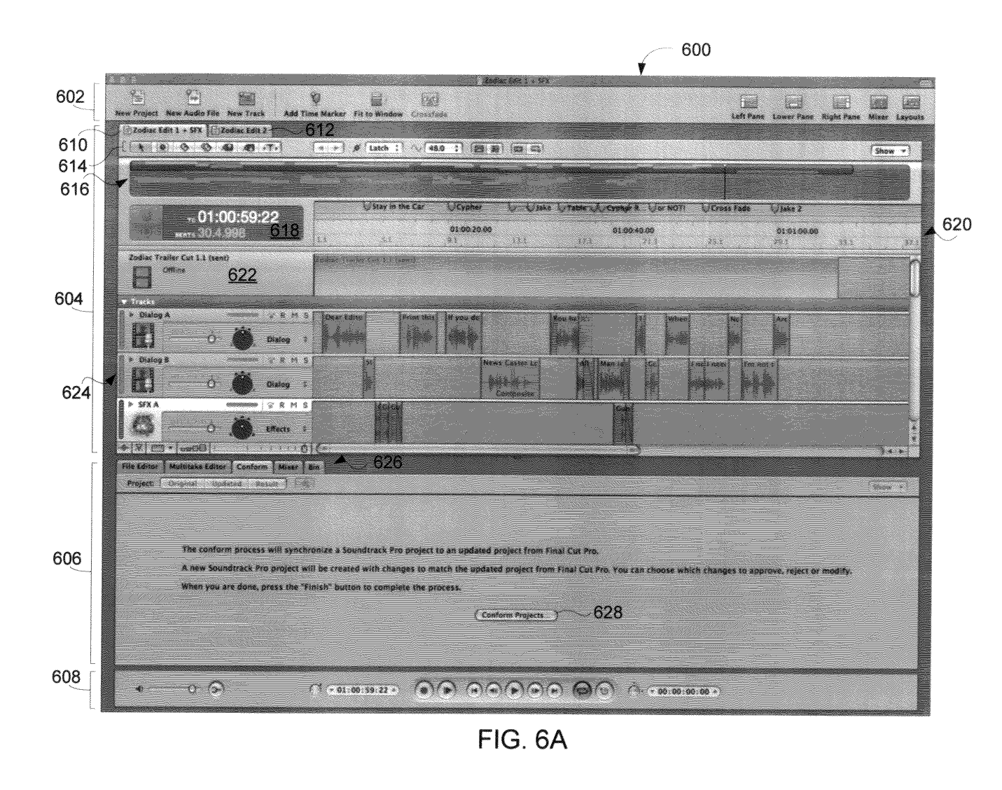

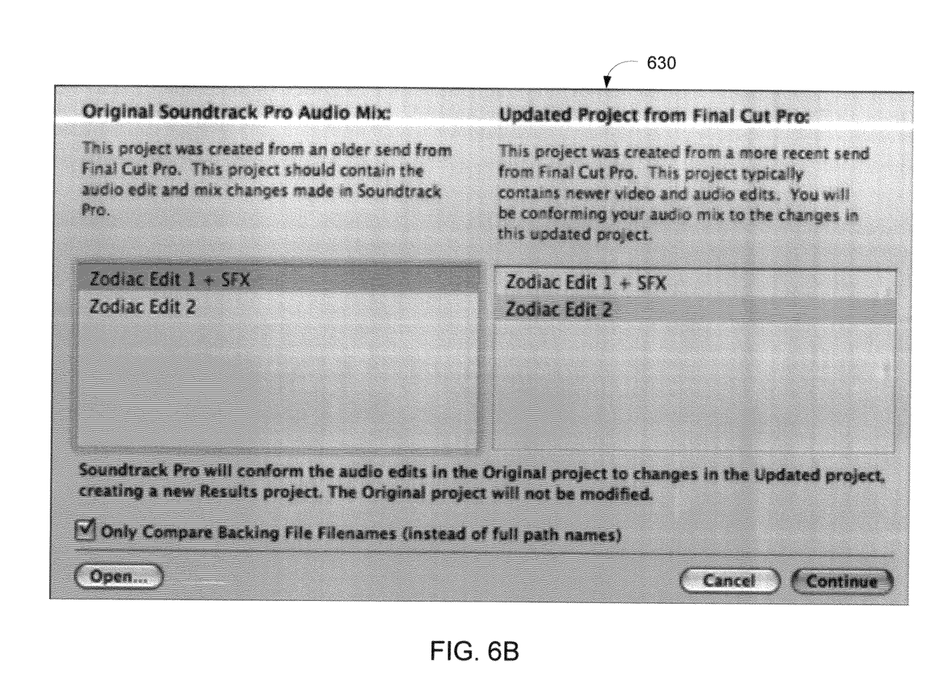

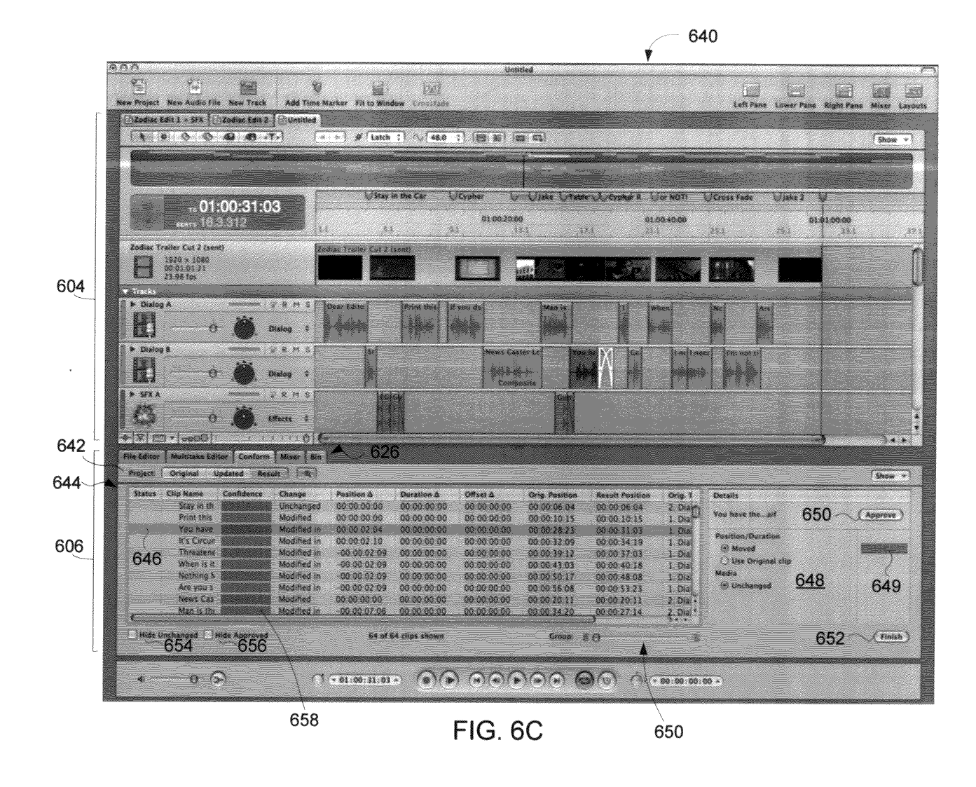

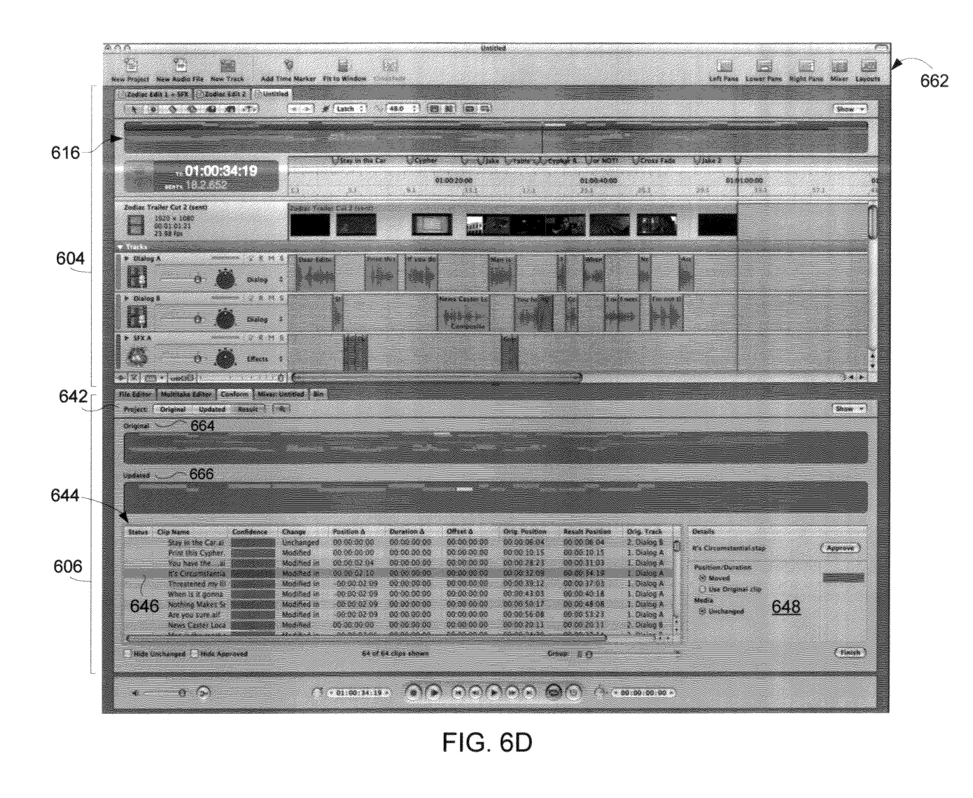

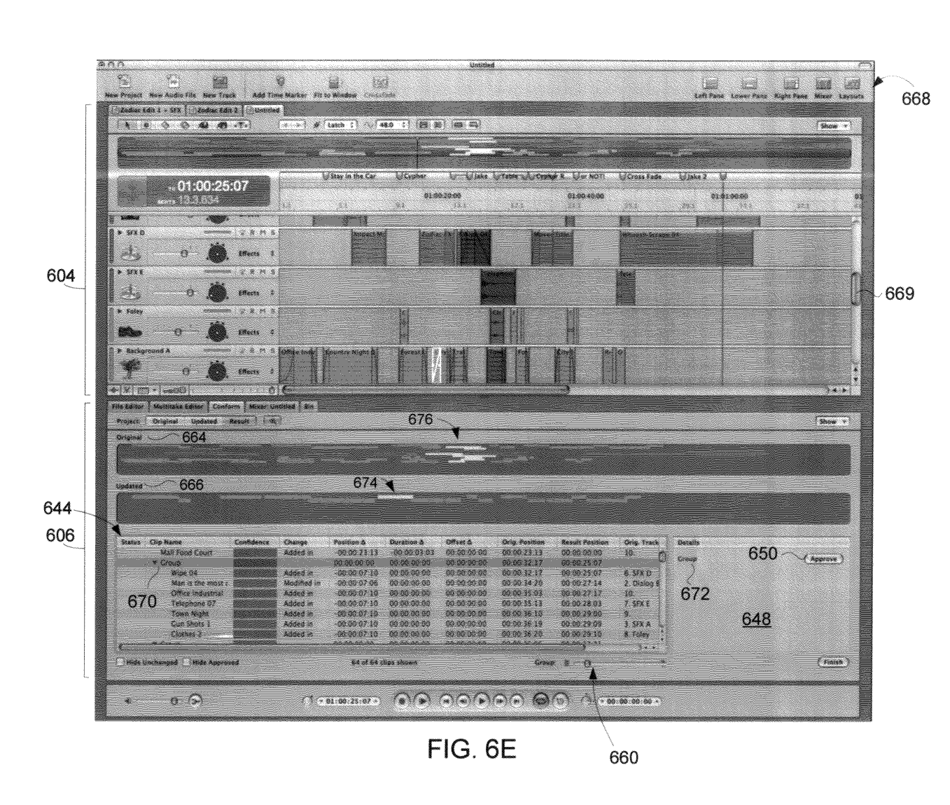

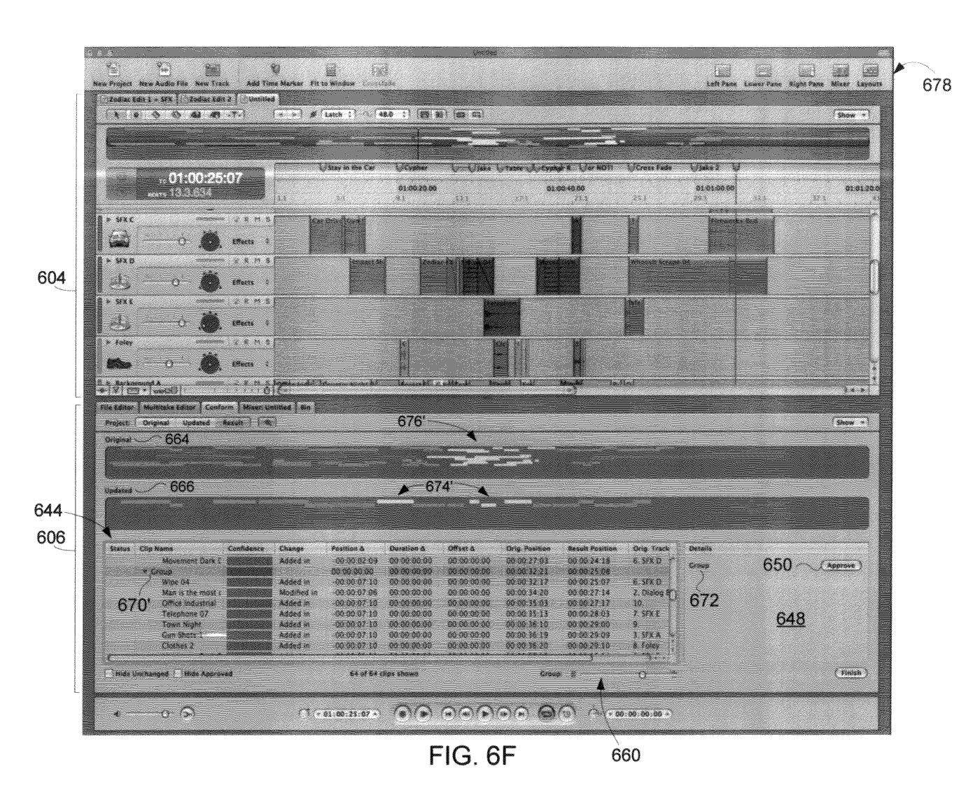

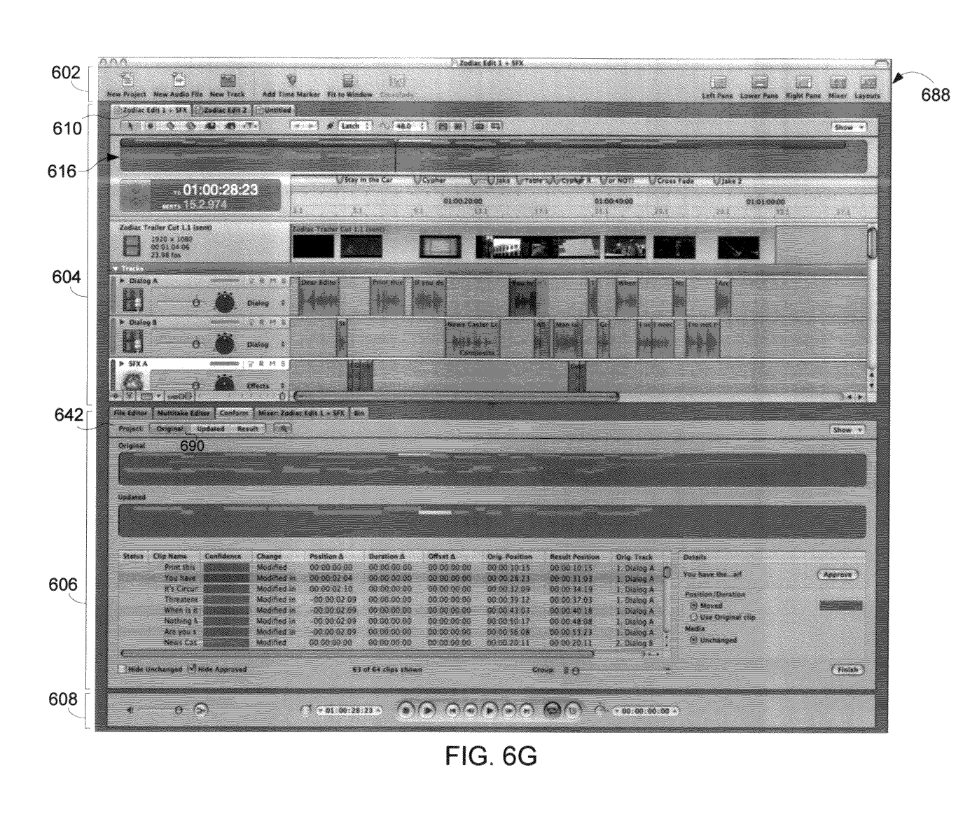

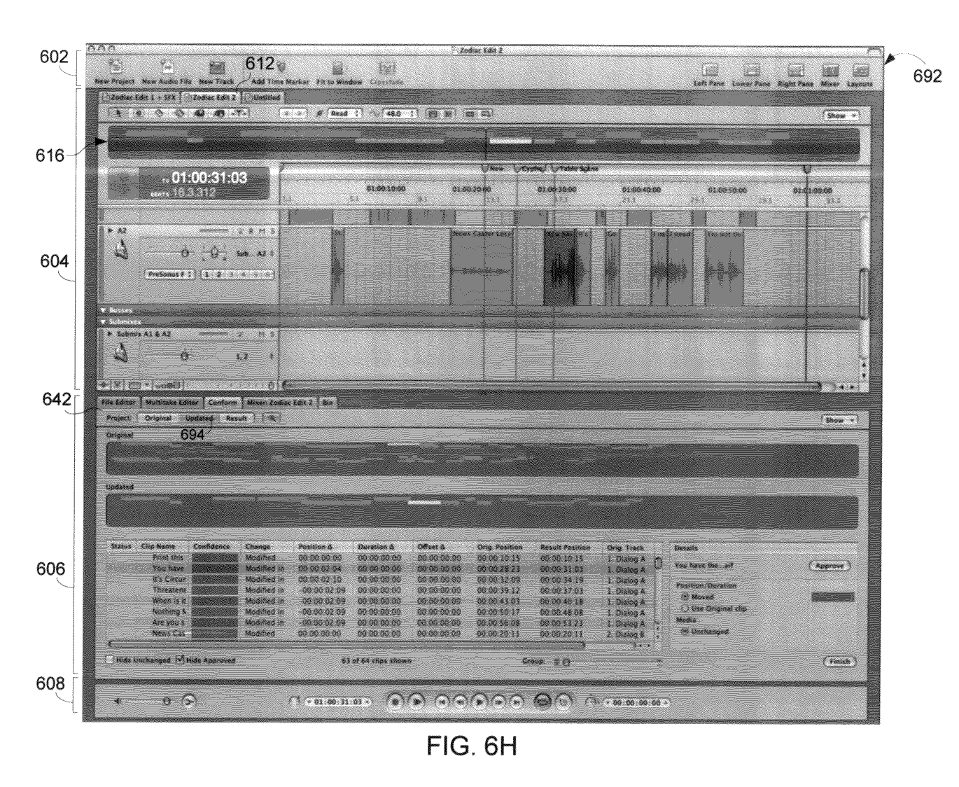

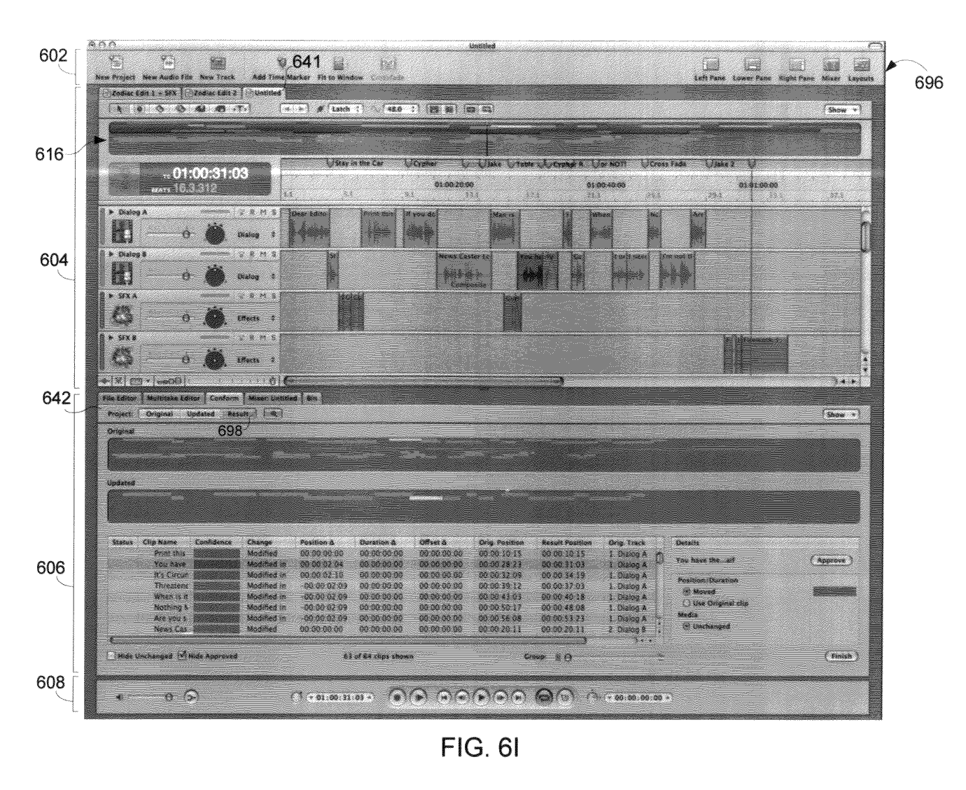

According to embodiment of the invention, the conform process can assist users in reviewing and approving proposed position and/or properties for audio clips being conformed from one multimedia project to another multimedia project. Many of these embodiments can utilize graphical user interface components. Various examples of graphical user interface components are discussed below in FIGS. 5-6I. As one example, as discussed below, audio clips can be grouped and reviewed and approved as a group. As another example, timelines can be linked with a selected audio clip being reviewed for approval. In one implementation, linking timelines allows a selected audio clip (or group of audio clips) to be distinctively displayed in such timelines to illustrate how they have changed between the various sequences. As another example, filtering audio clips to be reviewed based on various criteria can allow faster identification of clips that are still to be reviewed. As still another example, a confidence level can be determined and displayed for an audio clip to guide the user in reviewing the audio clip for approval.

FIG. 5 is an exemplary screenshot of a conform window 500 according to one embodiment of the invention. The conform window 500 is, for example, provided to assist a user of an audio production program in reviewing proposed modifications regarding audio elements in an effort to conform the audio elements provided for a first video cut to a second video cut.

The conform window 500 includes a first video timeline 502 that can pertain to an original project, and a second video timeline 504 that can pertain to an updated project. The conform window 500 also includes an audio clip review region 506. The audio clip review region 506 can provide information on proposed positioning of audio elements with respect to the updated project. The audio clip review region 506 displays a list of audio elements. For each of the audio elements, the audio clip review region 506 can display status, clip name, confidence, change (e.g., whether changed or type of change), position change, duration change, offset change, etc. A selected audio element 508 can be highlighted in the audio clip review region 506. The position of the selected audio element 508 can also be visually indicated (e.g., highlighted) in the first video timeline 502 at visual indicator 503 as well as in the second video timeline 504 at visual indicator 505. Also, for the selected audio element 508, the audio clip review region 506 can also provide a detail region 510. The detail region 510 can present detailed information concerning the nature of the modification of the audio element being proposed. For example, the detail region 510 can provide information on position, duration and/or media. The detailed region can also include (or have proximate thereto) a confidence indicator 511 and an approve control 512 (e.g., approve button). The confidence indicator 511 provides an indication of the degree of confidence (or confidence level) with the positioning of the selected audio element. The user can approve a proposed modification by selecting the approve control 512. The conform window 500 can also include a finish control 514 (e.g., finish button) to enable the user to end the review of the conform process.

The audio clip review region 506 can also include a status indicator 516 to visually indicate that the associated proposed modification has been approved. The status indicator 516 can be visually illustrated for each of the audio clips within the audio clip review region 506 that have been already approved by the user. In one embodiment, the status indicator 516 can be a graphical symbol such as a symbol, icon or the like. The approval of an audio clip within the audio clip review region 506 can, for example, be performed using the approve control 512. Advantageously, the user of the project edit window 506 can receive a visual indication of those of the audio clips within the audio clip review region 506 that have already been approved. Approval can, for example, denote acceptance of an associated proposed modification for an audio clip (or a group of audio clips).

The list of audio elements in the audio clip review region 506 can also be filtered using filter controls 518 and 520. The filter control 518 can operate to cause those of the proposed modifications that are “unchanged” to be hidden from being displayed in the list of audio elements in the audio clip review region 506. The filter control 520 can operate to cause those of the proposed modifications that have been “approved” to be hidden from being displayed in the list of audio elements in the audio clip review region 506. More particularly, upon selection of the filter control 520, those previously approved audio clips are removed from the audio clip review region 506. For example, since three of the audio clips are denoted as being approved by the status indicators 516, such particular audio clips would no longer be displayed in the audio clip review region 506 if the filter control 520 were activated. In other words, by selection of the filter control 520, those of the audio clips that have been approved are no longer presented in the audio clip review region 506. As such, the audio clip review region 506 can serve as a list of those remaining audio clips that have yet to be reviewed and approved by the user.

The confidence level 522 assigned to the proposed modifications in the list of audio element in the audio clip review region 506 can assist the user in determining whether to approve the proposed modifications. A group control 524 can be used to influence the extent to which audio clips are grouped together for review.

FIGS. 6A-6I are screenshots of exemplary graphical user interfaces according to embodiments of the invention. The graphical user interface can provide a project edit window that supports a conform process. In one embodiment, the project edit window can be presented by an audio production program (APP). One example of an audio production program (APP) is Soundtrack Pro 2™, an audio editing program available from Apple Inc. of Cupertino, Calif. USA.

FIG. 6A is a screenshot of a project edit window 600 according to one embodiment of the invention. The project edit window 600 includes a toolbar 602 containing various user controls for editing projects. The projects can pertain to multimedia projects that include audio and video components. The project edit window 600 includes a project edit pane 604, an editor pane 606, and a control pane 608. The project edit pane 604 includes a first project tab 610 and a second project tab 612. As illustrated in FIG. 6A, the first project tab 610 is selected, and the second project tab 612 is de-selected. The project edit pane 604 also includes edit tools 614, a project timeline view 616, a time display 618, a time ruler 620, a video track 622, and one or more audio tracks 624.

The editor pane 606 includes a plurality of selectable tabs 626. As illustrated in FIG. 6A, a conform tab is selected. The editor pane 606, when the conform tab is selected, operates to begin a conform process whereby a multimedia project undergoing concurrent video and sound editing can be synchronized to perform a new resulting project whereby the sound editing can be automatically provided on the updated project such that a user can choose to approve, reject or modify the various sound edits being proposed. The editor pane 606 includes a conform projects user control 628. Upon selection of the conform projects user control 628, a conform process can be initiated. When the conform tab is selected, the editor pane 606 can also be referred to as a conform pane since the editor pane 606 assumes a conform context.

The control pane 608 can include a playhead position control, transport controls, and a selection length control to facilitate editing of digital media assets associated with a multimedia project.

FIG. 6B is a screenshot of a selection screen 630 according to one embodiment of the invention. The selection screen 630 allows a user to select a first project and a second project which are to be processed (i.e., “conformed”) by the conform process. Typically, the first project is or includes a video sequence that has been audio edited, and the second project is an updated version of the video sequence (without the audio edits made to the first project). The conform process will operate, when files are selected, to propose positions and/or properties for the audio edits (that were made with respect to the first project) that are to be provided to the second project. The result is a resultant project that includes the updated video sequence together with the audio edits.

FIG. 6C is a screenshot of a project edit window 640 according to one embodiment of the invention. The project edit window 640 follows from the project edit window 600 after the first and second projects have been selected using the selection screen 630 illustrated in FIG. 6B.

The project edit window 640 includes the project edit pane 604 similar to that discussed above with respect to FIG. 6A. The project edit pane 604 includes a project tab 641 pertaining to a new project (untitled). Although the project tab 641 is shown selected in FIG. 6C, the other tabs 610 and 612 can be alternatively selected to switch to another of the available projects.

The project edit window 640 also includes the editor pane 606. In this embodiment, the editor pane 606 illustrates the conform tab being selected from the selectable tabs 626, and a graphical user interface for conform review. Namely, within the editor pane 606, the graphical user interface for conform review includes a project selection control 642 that enables a user to select a project to be displayed. In this embodiment, the project selection control 642 can select one of an original project, an updated project, or a result project.

As illustrated in FIG. 6C, the project selection tool 642 indicates selection of the result project that corresponds to the project tab 641. Alternatively, in the project selection tool 642 can be used to select the original project or the updated project.

The editor pane 606 also includes an audio clip review region 644. The audio clip review region 644 can provide information on proposed positioning and properties of audio elements with respect to the selected project. The audio clip review region 644 displays a list of audio elements. For each of the audio elements, the audio clip review region 644 can display various attributes (e.g., position and/or properties) for clips, including: status, clip name, confidence, change (e.g., whether changed or type of change), position change, duration change, offset change, etc. A selected audio element 646 can be highlighted. Also, for the selected audio element 646, the editor pane 606 can also provide a detail region 648. The detail region 648 can present detailed information concerning the nature of the modification of the audio element being proposed. For example, the detail region 648 can provide information on position, duration and/or media. The detail region 648 can also include (or have proximate thereto) a confidence indicator 649 and an approve control 650 (e.g., approve button). The confidence indicator 649 provides an indication of the degree of confidence (or confidence level) with the positioning of the selected audio element. The user can approve a proposed modification by selecting the approve control 650. The editor pane 606 can also include a finish control 652 (e.g., finish button) to enable the user to end the review of the proposed modifications provided by the conform process.

Also, in the event that the user desires to edit any of the media assets in the project edit pane 604, the user can do so at any time. Hence, the user is not limited to accepting proposed position and/or properties for the selected audio element 646 identified by the conform process but can choose to instead directly edit the corresponding media asset.

Further, the detail region 648 can indicate one or more possible states that the conform process identified for the selected audio element 646. Examples of possible states can include one or more of: added, moved, use original clip, and unchanged. The unchanged state means that the conform process is not suggesting positional change for a selected audio element. The states can also include media states that impact the media of the audio element. The media states can include one or more of: unchanged, slipped, and use original clip. A user can select one of the states to be utilized for the selected audio element 646 in the result project. If the user selects a different state than the current selected state, then the position (and/or properties) of the selected audio element 646 will be changed so that the information in the audio clip review region 644 is updated as needed. The project edit pane 604 can also be updated to indicate the updated position of the selected audio element 646.

In one embodiment, the conform process might in some cases not be able to reconcile changes for an audio clip between the modified original project and the updated project. For example, changes made to the modified original project and the updated project might conflict and require user decision to resolve. As another example, if the backing media for an audio clip is changed to a different media file, the conform process might not be able to resolve which media file (original or replacement) is to be used. The conform process can make its best guess for the desired position, but the audio clip can be visually identified as being conflicting. A graphical user interface can also provide alternative positions for a clip so that a user can elect to decline a default position (or the best guess) and instead select an alternative position. The list of audio elements in the audio clip review region 644 can also be filtered using filter controls 654 and 656. The filter control 654 can operate to cause those of the proposed modifications that are “unchanged” to be hidden from being displayed in the list of audio elements in the audio clip review region 644. The filter control 656 can operate to cause those of the proposed modifications that have been “approved” to be hidden from being displayed in the list of audio elements in the audio clip review region 644. A confidence level 658 assigned to the proposed modifications in the list of audio element in the audio clip review region 644 can assist the user in determining whether to approve the proposed modifications. The confidence level 658 can indicate the degree of confidence the conform process has in the proposed modification (e.g., proposed position) for a particular audio element. A group control 650 can be used to influence the extent to which audio clips are grouped together for review. In other embodiments, other filter controls can be used based on other conditions, such as confidence level, changes to media file, offset, name/text, etc.

FIG. 6D is a screenshot of a project edit window 662 according to one embodiment of the invention. In this embodiment, the editor pane 606 is expanded to show an original timeline 664 and an updated timeline 666. The timelines 664 and 666 illustrate representations of individual audio elements within the corresponding projects. The original timeline 664 can pertain to the original project (or the first project). The updated timeline 666 can pertain to the updated project (the second project). Further, the position of the selected audio element(s) 646 can be visually indicated in the first original timeline 664 as well as in the updated timeline 666. Besides the additional display of the original timeline 664 and the updated timeline 666, the editor pane 606 is generally similar to the editor pane 606 illustrated in FIG. 6C, which among other things depicts the audio clip review region 644.

In one embodiment, the selected audio element 646 can also be linked to the project timeline 616. In such case, when the selected audio element 646 is selected, the project timeline 616 can scroll horizontally to bring the corresponding portion into center view within the project edit window 662, and the playhead for playback can also be moved to align with the beginning of the selected audio element 646. Consequently, a user is able to visually appreciate the selected audio element in context of the project. The user can also easily initiate playback of the selected audio element if desired, which can be helpful when seeking to determine whether the proposed position of the selected audio element should be approved. Additionally, the selection of an audio element within the project timeline 616 can also cause the corresponding audio element in the list of audio elements list of audio elements in the audio clip review region 644 to be visually identified. Also, if a different state is selected from the detail region 648 for the selected audio element 646, display of an associated timeline (e.g., project timeline 616, updated timeline 666) can also update to distinctively identify the selected audio element 646 at the position corresponding to the selected state.

FIG. 6E is a screenshot of a project edit window 668 according to another embodiment of the invention. The project edit window 668 includes the project edit pane 604 that is generally similar to the project edit pane 604 illustrated in FIG. 6D. However, the project edit pane 604 is scrolled downward using a slider control 669. As such, it should be understood that the project edit pane 604 can support a plurality of video sequences as well as a plurality of audio tracks, submixes or busses. The ability to utilize the slider control 669 allows different ones of digital media assets (e.g., video sequences, audio tracks, etc.) to be displayed within the project edit pane 604 during project editing operations. The editor pane 606, as illustrated in FIG. 6E, can support grouping of individual audio components (e.g., audio clips) during the conform process. In this regard, the group control 660 can be manipulated by a user to indicate a degree of grouping to be utilized. As illustrated in FIG. 6E, the group control 660 is shown as selecting a small amount of grouping. When grouping is utilized, the audio clip review region 644 can display and approve certain of the audio clips (or audio elements) as a group. For example, as illustrated in FIG. 6E, a group indicator 670 can be displayed together with an indication of the particular audio clips that have been automatically associated with such group. In this implementation, the particular audio clips within the group designated by the group indicator 670 are distinctively displayed (e.g., indented) in the list of audio clips.

The audio clips being clustered into a group depends on the group control 660. The conform tool can, in one embodiment, group the audio clips based on how close together they are on a timeline, and how similarly they were changed between their states between the original project and the updated project. In one embodiment, the farther the group control 660 is moved (slid) to the right, the more the grouping constraints on groups are loosened, and when the group control 660 is moved to the far left, there are no groups. The audio clips within the selected group 670 are indicated within the original timeline 664 and also within the updated timeline 666. The original timeline 664 can include a visual indication 676 for each of the audio clips within the selected group 670, and the updated timeline 666 can include a visual indication 674 for each of the audio clips within the selected group 670. A visual comparison of the visual indications 676 and the visual indications 674 provides some perspective on the relative position changes that the associated audio clips have undergone.

Upon selection of the group within the audio clip review region 644, the detail region 648 can display a group indication 672. By selection of the approve control 650, the audio clips associated with the selected group 670 can be approved as a group. Hence, using the group control 660, facilitates efficient review of the audio clips that are to be reviewed within the audio clip review region 644.

FIG. 6F is a screenshot of a project edit window 678 according to another embodiment of the invention. The project edit window 678 is generally similar to the project edit window 668 illustrated in FIG. 6E. However, the group control 660, as depicted in FIG. 6F, has been moved to a position so that a large amount of grouping is performed with respect to the audio clips within the audio clip review region 664. As illustrated in FIG. 6F, a group indicator 670′ indicates that a group is formed and the group includes a plurality of audio clips. The audio clips within the selected group 670′ are indicated within the original timeline 664 and also within the updated timeline 666. The original timeline 664 can include a visual indication 676′ for each of the audio clips within the selected group 670′, and the updated timeline 666 can include a visual indication 674′ for each of the audio clips within the selected group 670′. A visual comparison of the visual indications 676′ and the visual indications 674′ provides some perspective on the relative position changes that the associated audio clips have undergone. On selection of the selected group 670′, the detailed region 648 can present the group indicator 672 and the approve control 650. The selection of the approve control 650 operates to approve each of the audio clips that are contained within the selected group 670′.

FIG. 6G is a screenshot of a project edit window 688 according to one embodiment of the invention. The project edit window 688 is generally similar to the project edit window 640 illustrated in FIG. 6B. However, in the project edit window 688, the project selection control 642 indicates selection of the original project 690 that corresponds to the project tab 610. This enables the audio elements to be examined in different contexts (original, updated, result). Hence, the global timeline 616 now pertains to the original project as do the various video and/or audio tracks illustrated in the project edit pane 604.

FIG. 6H is a screenshot of a project edit window 692 according to one embodiment of the invention. The project edit window 692 is generally similar to the project edit window 688 illustrated in FIG. 6G. However, in the project edit window 692, the project selection control 642 indicates selection of the updated project tab 694 that corresponds to the project tab 612. Hence, the global timeline 616 now pertains to the updated project as do the various video and/or audio tracks illustrated in the project edit pane 604.

FIG. 6I is a screenshot of a project edit window 696 according to one embodiment of the invention. The project edit window 696 is generally similar to the project edit window 688 illustrated in FIG. 6G. However, in the project edit window 696, the project selection control 642 indicates selection of the result project tab 698 that corresponds to the project tab 641. Hence, the global timeline 616 now pertains to the result project as do the various video and/or audio tracks illustrated in the project edit pane 604.

To assist with locating of clips in different video cuts (or sequences), each clip can be provided with an identifier. The identifiers can thus be used to locate clips that have moved or otherwise altered in the different video cuts. An identifier is, for example, a unique identifier (UID). The VPP 102 or the APP 104 can operate to assign identifiers to the clips. A clip can have a plurality of identifiers so that its history can be understood. Each clip can thus have its lineage in a series of identifiers. New clips are assigned identifiers. New clips can result from adding a clip, splitting a clip, duplicating a clip, or copying & pasting a clip. For example, it is fairly common for one initial clip to be split into two or more clips during editing. A clip that is split into two clips will yield two clips with each having the identifier of the initial clip as well as having a new unique identifier for each new clip. The identifiers can be assigned to clips when the clips are created or when exported by VPP 102 to AAP 104, or when imported by AAP 104 from VPP 102. The identifier history for a multimedia project having the clips can be provided in a markup language (e.g., XML) format.

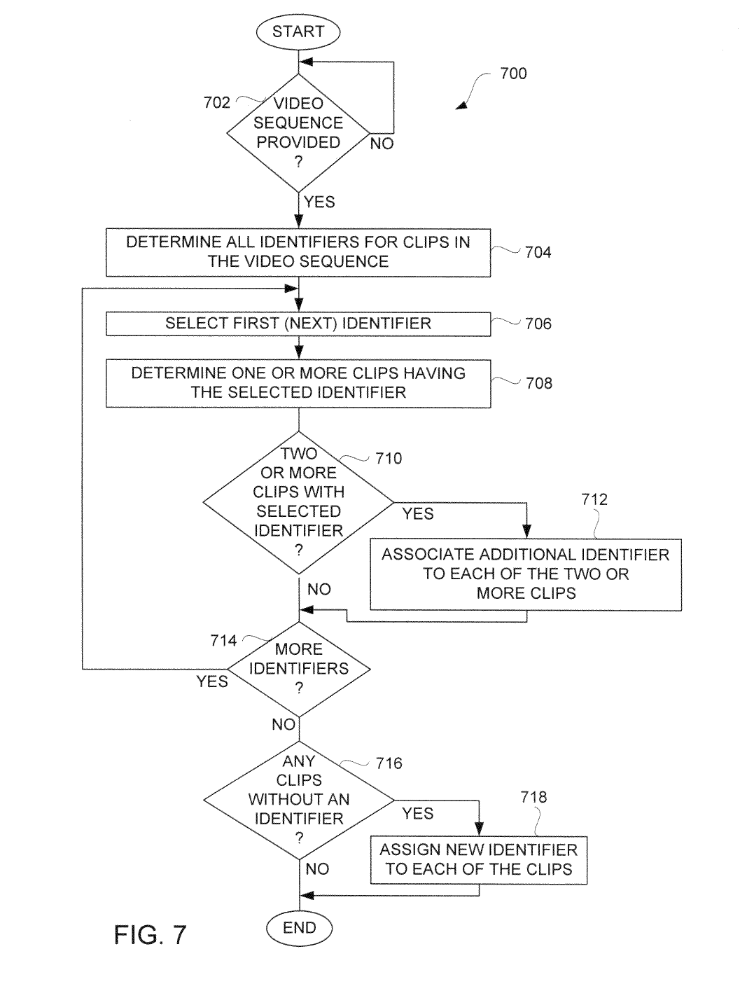

FIG. 7 is a flow diagram of a clip identification process 700 according to one embodiment of the invention. The clip identification process 700 serves to identify the clips with unique identifiers. The identifiers for the clips are used by the conform process 200 illustrated in FIG. 2A or the conform process 300 illustrated in FIGS. 3A and 3B. The clip identification process 700 is, for example, processing that can be carried out before block 208 of the conform process 200 illustrated in FIG. 2B or before block 318 of the conform process 300 illustrated in FIG. 3A.

The clip identification process 700 can begin with a decision 702. The decision 702 can determine whether a video sequence is being provided. For example, a video sequence can be provided by being exported from the VPP 102 and imported by the APP 104. When the decision 702 determines that a video sequence is not being provided, the clip identification process 700 can await until a video sequence is being provided. Once the decision 702 determines that a video sequence is being provided, all identifiers for clips in the video sequence are determined 704. A first of the identifiers is then selected 706. One or more clips having the selected identifier can then be determined 708. Next, a decision 710 can determine whether two or more clips have the selected identifier. For example, clips can have the same identifier due to a split or duplication of the clip. When the decision 710 determines that two or more clips have the selected identifier, an additional identifier (i.e., unique identifier) can be associated 712 to each of the two or more clips having the selected identifier.

Following the block 712, or directly following the decision 710 when there are no new clips, a decision 714 determines whether there are more identifiers. When the decision 714 determines that there are more identifiers, the clip identification process 700 can return to repeat the block 706 and subsequent blocks so that a next identifier can be selected 706 and similarly processed. Once the decision 714 determines that there are no more identifiers to be processed, a decision 716 can determine whether there are any remaining clips, namely new clips, without an identifier. When the decision 716 determines that there are new clips without an identifier, a new identifier can be assigned 718 to each of the new clips. Following the block 718, or directly following the decision 716 when all clips have identifiers, the clip identification process 700 can end.

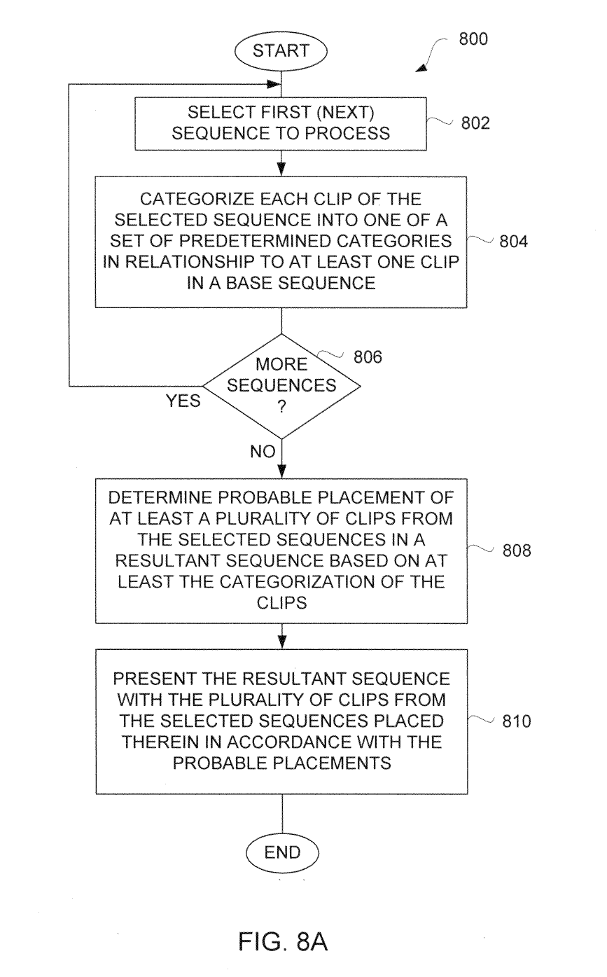

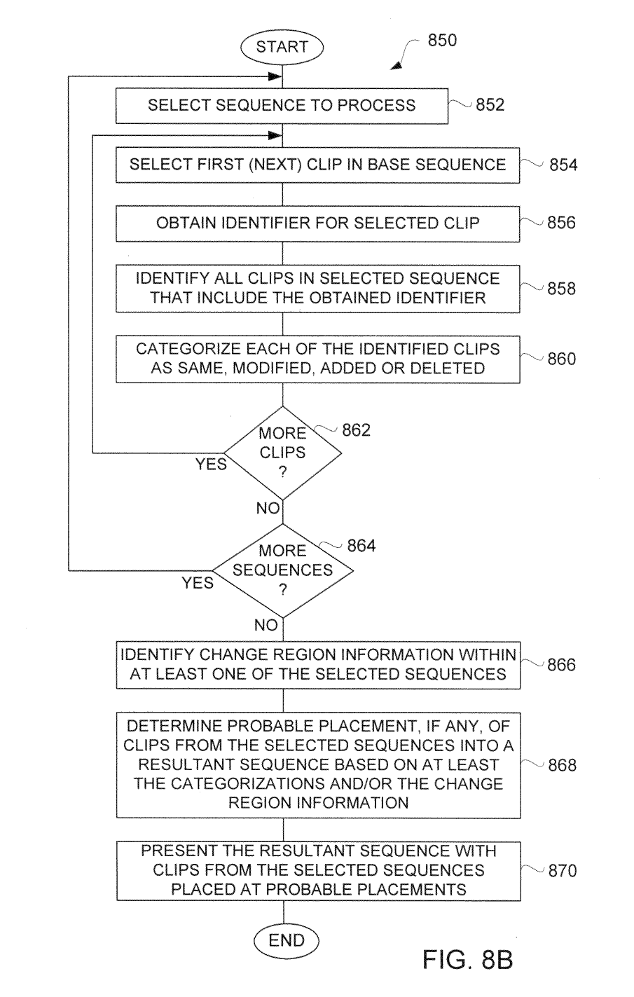

FIG. 8A is a flow diagram of the clip placement process 800 according to one embodiment of the invention. The clip placement process 800 is, for example, processing that can be performed by the block 208 illustrated in FIG. 2A or the blocks 318 and 320 of FIG. 3A.

The clip placement process 800 operates to process or more sequences as discussed below. The clip placement process 800 can initially select a first sequence to be processed. The sequence being selected is typically a media sequence having a plurality of clips. The sequence is typically part of a project which includes one or more different sequences. After the first sequence to be processed has been selected 802, each clip of the selected sequence can be categorized 804 into one of a set of predetermined categories in relationship to at least one clip in a base sequence. Next, a decision 806 can determine whether there are more sequences to be processed. When the decision 806 determines that there are more sequences to be processed, the clip placement process 800 returns to repeat the block 802 so that a next sequence can be selected and processed in a similar fashion.

On the other hand, when the decision 806 determines that there are no more sequences to be processed, probable placement of at least a plurality of clips from the selected sequence in a resultant sequence can be determined 808 based on at least the categorization of the clips. Here, in conforming the sequences, clips are processed so as to be intelligently conformed to the resultant sequence. Next, the resultant sequence with the plurality of clips from the selected sequences placed therein in accordance with the probable placements can be presented in 810. Following the block 810, the clip placement process 800 can end.

FIG. 8B is a flow diagram of the clip placement process 850 according to one embodiment of the invention. The clip placement process 850 is, for example, processing that can be performed by the block 208 illustrated in FIG. 2A or the blocks 318 and 320 of FIG. 3A.

The clip placement process 850 can initially select 852 a sequence to process. The selected sequence is processed in comparison to a base sequence. A first clip in the base sequence can be selected 854. An identifier for the selected clip can then be obtained 856. Thereafter, all clips in the selected sequence that include the obtained identifier can be identified 858. Each of the identified clips can then be categorized 860 as same, modified, added or deleted. A decision 862 can then determine whether there are more clips to be processed. When the decision 862 determines that there are more clips to be processed, the clip placement process 850 can return to the block 854 so that a next clip in the base sequence can be selected and similarly processed.

On the other hand, when the decision 862 determines that there are no more clips in the selected sequence to be processed, a decision 864 determines whether there are more sequences to be processed. Typically, two sequences, namely, a first sequence (e.g., first video sequence or first video cut) and a second sequence (e.g., second video sequence or second video cut) are processed. When the decision 864 determines that there are more sequences to be processed, the clip placement process 850 can return to repeat the block 852 so that another sequence to be processed can be selected and similarly processed.

Alternatively, when the decision 864 determines that there are no more sequences to be processed, the clip placement process can identify 866 change region information within at least one of the selected sequences. For example, the change region information can consider were the first and second sequences have contiguous sections that have been moved or deleted. More generally, the first and second sequence can be analyzed to locate regions that have particular meaning,

Probable placements, if any, of the clips from the selected sequences into a resultant sequence can then be determined 868. In the determination 868 of the probable placement of the clips into the resultant sequence, the clip placement process 850 can be based on at least the categorizations and/or the change region information. Thereafter, the resultant sequence with clips from the selected sequences that have been placed at probable placements can then be presented 870. After the resultant sequence has been presented 870, the clip placement process 850 can end.

In one embodiment, the blocks 856 and 858 use a unique identifier (UID) to identify clips in a selected sequence that match clips in a base sequence. Typically, this is performed for two different selected sequences, a first sequence and a second sequence. At block 860, the identified clips in the selected sequence can be categorized into different lists of clips. These different lists of clips can include: added clip list, deleted clip list, same clip list, and modified clip list. For a given selected clip in the base sequence, if there are no identified clips in the selected sequence that match, then the selected clip has been deleted. In this case, the selected clip is added to the deleted clip list. If the selected clip in the base sequence has a matching clip in the selected sequence, then the properties of the respective clips can be compared to determine whether the clip has been modified. For example, a clip in the selected sequence can be modified as compared to the base sequence by being moved in the sequence, by being re-sized, by changing its underlying media, by changing media offset, or by changing tracks. In any event, if the clip has not been modified, then the matching clip in the selected sequence is added to the same clip list. Alternatively, if the clip has been modified, the matching clip is added to the modified clip list.

When UIDs are used, categorization of the identified clips with respect to the different lists of clips can be performed as follows. If the identified clip has a UID in the base sequence but not the selected sequence, the identified clip is deemed a deleted clip and thus is added to the deleted clip list. If the UID of the identified clip in the selected sequence is not in the base sequence, the identified clip is deemed an added clip and thus added to the added clip list. Further, if the identified clip in the selected sequence does not have a UID, the identified clip can also be deemed an added clip and thus added to the added clip list.

In some cases, there may be more than one matching clip in the selected sequence. These matching clips can be processed in various different ways. In one embodiment, considering properties of the matching clips as compared to the properties of the selected clip in the base sequence, the best matching clip is determined and such matching clip can be added to the modified clip list. The remaining matching clips are treated as newly added clips and are placed in the added clip list. In one implementation, if one or more of the matching clips overlap the length of the selected clip in the base sequence, such clips can be deemed related and all such related matching clips can be added to the modified clip list, with any remaining, non-related matching clips being placed in the added clip list. Multiple matching clips can be deemed related to a selected clip in the base sequence, such can occur, for example, when a clip is split into two parts that roughly stay together.

In another embodiment, when the clips to not have identifiers (e.g., UIDs) that can be used to determine those clips that match, a heuristic approach can be utilized. As an example, a heuristic can consider various properties of clips, such as start time, length, slip (offset) and/ media, to compute a probability of clips matching one another. The properties can be weighted differently. Those one or more properties that have a probability greater than a threshold amount can be considered matching clips. For example, if a clip in the selected sequence does not match any of the identified clips in the base sequence above the threshold amount, then the clip is considered an added clip. As another example, if no clip in the resultant sequence matches an identified clip in the base sequence above the threshold amount, then the clip is considered a deleted clip.

In one implementation, the probability is a number between zero and one can be assigned to each of the identified clips. In one embodiment, the identified clips are considered with respect to the selected clip in the base sequence. For a given identified clip, the identified clip having the highest probability of matching the selected clip is chosen. If the highest probability of all the one or more identified clips with respect to the chosen clip is zero, then the chosen clip is deemed a deleted clip and thus is added to the deleted clip list.

On the other hand, if the highest probability of all the one or more identified clips with respect to the chosen clip is greater than zero, further processing can categorize each of the one or more identified clips as added, modified or same. If the chosen clip has a probability of zero, there is no matching clip, so the chosen clip is treated as a newly added clip and thus placed in the added clip list. If the chosen clip has a probability of one, it is considered a matching clip, so the chosen clip is treated as the same and placed in the same clip list. Otherwise, if the chosen clip has a probability greater than zero but less than one, the chosen clip is probably a matching clip, so the chosen clip is placed in the modified clip list.

In one embodiment, the block 868 determines probable placements of clips from the selected sequences into the resultant sequence using the different lists of clips, namely, added clip list, deleted clip list, same clip list, and modified clip list, for each of the first and second sequences. The probable placements can be configured as default placements. Optionally, the probable placements can include one or more alternative placements. Probable placement of clips from the selected sequence into the resultant sequence can be determined as follows:

A. Those clips in both the same clip list for the first sequence and the same clip list for the second sequence are considered unchanged clips and are therefore added to the resultant sequence.

B. Those clips in the added clip list for the second sequence are added clips and are therefore added to the resultant sequence.

C. Those clips in the deleted clip list for the second sequence are either deleted or provided in the resultant sequence. If such clips are also in the same clip list for the first sequence, then the clips can be deleted (i.e., not added to the resultant sequence). If such clips are not also in the same clip list for the first sequence, then such clips can be added to the resultant sequence.

D. Those clips in the modified clip list for the second sequence are either provided in the resultant sequence, merged into the resultant sequence or deleted. If such clips are also in the same clip list for the first sequence, then the clips can be added to the resultant sequence. If such clips are also in the deleted clip list for the first sequence, then such clips can be deleted (i.e., not added to the resultant sequence). If such clips are also in the modified clip list for the second sequence, then such clips can be added to the resultant sequence in a manner that merges the changes from both the first sequence and the second sequence. For example, an effort is made to preserve changes made to both the first sequence and the second sequence. Multiple options can also be provided particularly when the changes conflict such that changes are not able to be preserved. For example, if the second sequence was modified by moving a video clip thirty seconds forward in time and the first sequence was modified by moving an audio clip one second forward in time, the resultant sequence can include the modified clip from the second sequence at its modified position thirty seconds forward in time and also the modified clip from the first sequence at a modified position thirty-one seconds forward in time. Here, the modified clip from the first sequence is able to be positioned relative to the moved position of the associated clip of the second sequence.

E. Those clips in the same clip list for the second sequence are either deleted or provided in the resultant sequence. If such clips are also in the deleted clip list for the first sequence, then the clips can be deleted (i.e., not added to the resultant sequence). If such clips are in the modified clip list for the first sequence, then such clips can be added to the resultant sequence while retaining the modifications to such clips via the first sequence.

F. Those clips in the added clip list for the first sequence are added to the resultant sequence. If the corresponding portion (i.e., overlapping portion) of the second sequence has moved, the placement of the clips in the resultant sequence can depend on the movement of the second sequence. For example, if a clip (or series of clips) was modified by a positional movement in the second sequence, the clip added in the first sequence can be placed in the resultant sequence by applying the positional movement to the clip being added. Optional placement for these clips can be its original placement which can also be made available as another alternative.

In one embodiment, when it is determined that an original clip is split into a plurality of clips in the first sequence (which still overlap with the position of the original clip), then they can be considered as a group to make the confirm process more manageable and more user friendly. Also, when the original clip is separately and concurrently moved in the second sequence, the plurality of the clips in the first sequence can be treated as a group and all be moved in the same manner in which the original clip was moved in the second sequence.

In one embodiment, the media (or media content) used by a clip (e.g., audio clip) can be used as a factor in determining where to position the clip in the resultant sequence. For example, when the position of a media clip (e.g., video clip) differs between the first sequence and the second sequence, processing can evaluate whether an audio clip being provided in the resultant sequence should utilize a position corresponding to the media clip in the first sequence or in the second sequence. For example, such processing can analyze media content for information (“media content information”), such as time overlap or regions of important media content such as high amplitude or voice-spectrum audio content. The media content information can then be used to assist in making the positional determination (e.g., recommendation). In one implementation, time overlap can consider the duration of time the audio clip overlaps video clip(s) in determining position of the audio clip in the resultant sequence. As an example, if an audio clip overlaps both a first video clip and a second video clip in the first sequence, the audio clip can be considered to be more probable to be positioned with the video clip that most overlaps the audio clip. In one implementation, the audio content of the audio clip can be examined and used in determining position of the audio clip in the resultant sequence. As an example, if an audio clip overlaps both a first video clip and a second video clip in the first sequence, the audio clip can be considered to be more probable to be positioned with the video clip that overlaps with meaningful audio content of the audio clip. For example, if the audio content of the audio clip is more meaningful at the last twenty-five percent of its duration, then the portion of the video clip that best overlaps that more significant portion of the audio content can be considered to be the more probable position for the audio clip. The analysis of the audio content to determine more meaningful regions can, for example, be based on volume level and/or frequency spectrum, since greater volume and/or content with an interesting frequency signature (e.g., voice-spectrum audio indicating dialogue) may signal more important audio.

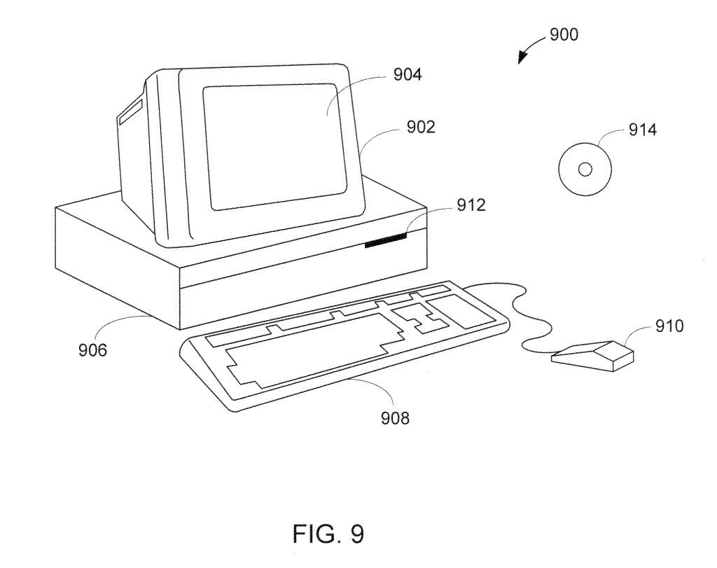

FIG. 9 shows an exemplary computer system 900 suitable for use with the invention. The methods, processes and/or graphical user interfaces discussed above can be provided by a computer system. The computer system 900 includes a display monitor 902 having a single or multi-screen display 904 (or multiple displays), a cabinet 906, a keyboard 908, and a mouse 910. The cabinet 906 houses a processing unit (or processor), system memory and a hard drive (not shown). The cabinet 906 also houses a drive 912, such as a DVD, CD-ROM or floppy drive. The drive 912 can also be a removable hard drive, a Flash or EEPROM device, etc. Regardless, the drive 912 may be utilized to store and retrieve software programs incorporating computer code that implements some or all aspects of the invention, data for use with the invention, and the like. Although CD-ROM 914 is shown as an exemplary computer readable storage medium, other computer readable storage media including floppy disk, tape, Flash or EEPROM memory, memory card, system memory, and hard drive may be utilized. In one implementation, a software program for the computer system 900 is provided in the system memory, the hard drive, the drive 912, the CD-ROM 914 or other computer readable storage medium and serves to incorporate the computer code that implements some or all aspects of the invention.

Additional details on media production are contained in: (i) U.S. patent application Ser. No. 11/735,468, filed Apr. 14, 2007, and entitled “MULTI-TAKE COMPOSITING OF DIGITAL MEDIA ASSETS,” which is hereby incorporated herein by reference; (ii) U.S. Provisional Patent Application No. 60/911,884, filed Apr. 14, 2007, entitled “TECHNIQUES AND TOOLS FOR MANAGING ATTRIBUTES OF MEDIA CONTENT,” which is herein incorporated herein by reference; and (iii) U.S. patent application Ser. No. 11/735,466, filed Apr. 14, 2007, and entitled “MULTI-FRAME VIDEO DISPLAY METHOD AND APPARATUS,” which is hereby incorporated herein by reference.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium (i.e., computer readable storage medium) include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different aspects, embodiments or implementations may, but need not, yield one or more of the following advantages. One advantage of the invention is that digital media assets (e.g., audio clips) associated with a first video cut can be automatically processed to be placed on a second video cut. Another advantage of the invention is that placement of audio clips from one video cut to a subsequent video cut can be automatically proposed. Still another advantage of the invention is that proposed placement of digital media assets can be efficiently reviewed for approval or disapproval.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer readable medium including at least executable computer program code tangibly stored thereon for editing a media sequence, said computer readable medium comprising:
computer program code for receiving a first media cut of a multimedia project;
computer program code for associating a plurality of media elements to the first media cut;
computer program code for receiving a second media cut of the multimedia project;
computer program code for analyzing the first media cut and the second media cut to propose modification of the media elements with respect to the second media cut; and
computer program code for accepting, declining or modifying the proposed modification of the media elements with respect to the second media cut.

2. A computer readable medium as recited in claim 1, wherein said computer program code for accepting, declining or modifying the proposed modification of the audio elements comprises presenting a graphical user interface on a display device, the graphical user interface including at least a list of the media elements and the proposed modification for such, wherein each of the media elements in the list of media elements is user-selectable.

3. A computer readable medium as recited in claim 2, wherein the graphical user interface further includes at least one user control configured to enable a user to accept a proposed modification for a selected one of the media elements in the list of media elements.

4. A computer readable medium as recited in claim 2, wherein the graphical user interface further includes at least one grouping control configured to enable a user to set a grouping setting that influences the degree of grouping of the media elements in the list of media elements.

5. A computer readable medium as recited in claim 1, wherein the first media cut is a first video cut, the second media cut is a second video cut, and the media elements are audio elements.

6. A computer-implemented method for merging media sequences, said method comprising:
identifying a first media sequence having a plurality of media elements that have been associated therewith;
altering the first media sequence to provide an altered first media sequence having a plurality of media elements that have been associated therewith;
identifying a second media sequence that resulted from editing of the first media sequence; and
determining where a plurality of the media elements that are associated with the altered first media sequence might likely be positioned with respect to the second media sequence.

7. A computer-implemented method as recited in claim 6, wherein said method further comprises:
forming a third media sequence from the second media sequence and a plurality of the media elements associated with the altered first media sequence, wherein the media elements associated with the altered first media sequence are provided at the determined likely positions within the third media sequence.

8. A computer-implemented method as recited in claim 6, wherein said determining of where a plurality of the media elements that are associated with the altered first media sequence might likely be positioned comprises:
determining a proposed position for each of the plurality of the media elements; and
assisting a user in reviewing the proposed positions for each of the plurality of the media elements.

9. A computer-implemented method as recited in claim 8, wherein said assisting of the user in reviewing the proposed positions for the media elements comprises presenting one or more user interface controls that enable the user to accept, decline or modify the proposed positions for the media elements.

10. A computer-implemented method as recited in claim 8, wherein said assisting comprises displaying the media elements in a list

11. A computer-implemented method as recited in claim 10, wherein said displaying of the media elements in the list comprises:
specifying a criterion;
filtering out those of the media elements that do not satisfy the criterion; and
displaying in a list those of the media elements that have not been filtered out.

12. A computer-implemented method as recited in claim 10, wherein said displaying of the media elements in the list comprises:
filtering out those of the media elements that have already been accepted; and
displaying in a list those of the media elements that have not yet been accepted.

13. A computer-implemented method as recited in claim 10, wherein on selection of one of the media elements in the list, the position of the selected media element within the third media sequence is visually distinctively displayed.

14. A computer-implemented method as recited in claim 10, wherein a portion of the media elements in the list are grouped together and able to be edited or approved as a group.

15. A computer-implemented method as recited in claim 6, wherein said determining of where the media elements should be positioned comprises:
determining proposed positions for the media elements; and
presenting a graphical user interface to facilitate user review of the proposed positions for the media elements.

16. A graphical user interface for a computing device, said graphical user interface comprising:
an editor pane configured to display a media clip review region that displays a list of media clips with proposed modifications for at least one of the media clips,
wherein the media clips were previously associated with a first media sequence and the proposed modifications are to transition the media clips to a second media sequence, the second media sequence being derived from the first media sequence.

17. A graphical user interface as recited in claim 16, wherein said graphical user interface comprises:
a timeline configured to present at least one of a first timeline or a second timeline, the first timeline being for the displaying a time-based representation of the first media sequence and the second timeline being for the displaying a time-based representation of the second media sequence.

18. A graphical user interface as recited in claim 17, wherein the media clips in the displayed list of media clips are linked to corresponding segments in the first media sequence in the first timeline and in the second media sequence in the second timeline.

19. A graphical user interface as recited in claim 18, wherein on selection of one of the media clips in the displayed list of media clips, the corresponding segments in the first timeline and the second timeline are caused to be distinguishably displayed.

20. A graphical user interface as recited in claim 18, wherein on selection of one of the segments in the first timeline or the second timeline, the corresponding media clip in the displayed list of media clips is caused to be distinguishably displayed.

21. A graphical user interface as recited in claim 16, wherein the proposed modifications for at least one of the media clips comprise a proposed modified position.

22. A graphical user interface as recited in claim 16, wherein the proposed modifications for at least one of the media clips comprise a proposed modified property.

23. A graphical user interface comprising:
a timeline pane configured to present at least one of a first timeline or a second timeline, the first timeline being for a first video sequence and the second timeline being for a second video sequence; and
an editor pane configured to display an audio clip review region that displays a list of audio clips with proposed modifications with respect to the second video sequence or a third video sequence derived from the second video sequence,
wherein the audio clips in the list of audio clips were previously associated with the first video sequence but not the second video sequence, and wherein at least a subset of the audio clips in the list of audio clips are automatically transitioned to the second video sequence or the third video sequence with the proposed modifications.

24. A graphical user interface as recited in claim 23, wherein said editor pane includes at least one user control for facilitating user review of the proposed modifications for the audio clips in the list of audio clips.

25. A graphical user interface as recited in claim 23, wherein the list of audio clips is displayed in said editor pane in a table format, with the audio clips displayed in rows and with a plurality of different properties for the audio clips provided in columns.

26. A graphical user interface as recited in claim 23, wherein the plurality of different properties for the audio clips are selected from the group consisting of: change indication, positional change, duration change, offset change, original position, resulting position.

27. A graphical user interface as recited in claim 23, wherein said editor pane further displays a confidence indication for the proposed modification for at least one of the audio clips in the list of audio clips.

28. A graphical user interface as recited in claim 23, wherein said editor pane further displays a change in position indication that indicates the change in position of at least one of the audio clips in the list of audio clips when being positioned in the second video sequence at a different position that was had in the first video sequence.

29. A graphical user interface as recited in claim 23, wherein the change in position indicator is a location relative to a timeline.

30. A graphical user interface as recited in claim 23, wherein the change in position indicator is a numerical value displayed in the edit pane.

31. A graphical user interface as recited in claim 23, wherein said editor pane further comprises a detail region that dynamically displays information pertaining to a selected one of the audio clips in the list of audio clips.

32. A graphical user interface as recited in claim 23, wherein said editor pane further comprises an acceptance control that enables a user to accept a proposed modification of a selected one or more of the audio clips in the list of audio clips.

33. A graphical user interface as recited in claim 23, wherein said editor pane further comprises a grouping control configured to implement automatic grouping of the audio clips in the list of audio clips.

34. A graphical user interface as recited in claim 23, wherein said editor pane further comprises a filter control configured to filter out from the list of audio clips those of the audio clips that have already been accepted.

35. A graphical user interface as recited in claim 23, wherein said editor pane further comprises a filter control configured to filter out from the list of audio clips those of the audio clips that have not been modified.
